(19) United States
(12) Patent Application Publication
(10) Pub. No.: US 2024/0388045 A1
(43) Pub. Date: Nov. 21, 2024

(54) Connector Structure, and Male Connector

(71) Applicant: Yazaki Corporation, Tokyo (JP)

(72) Inventors: Motoyoshi Suzuki, Shizuoka (JP); Tomoyoshi Fukaya, Shizouka (JP); Tomoki Hatakeyama, Tokyo (JP)

(21) Appl. No.: 18/642,129

(22) Filed: Apr. 22, 2024

(30) Foreign Application Priority Data
May 17, 2023 (JP) 2023-081736

(51) Int. Cl. H01R 13/703

(52) U.S. Cl. CPC H01R 13/7031

(57) ABSTRACT

A connector structure includes a male connector including a plurality of male terminals, a short spring coming into contact with the plurality of male terminals, and a male housing configured to house the plurality of male terminals and the short spring, and a female connector including a plurality of female terminals electrically connected to the plurality of male terminals and a female housing configured to house the plurality of female terminals. The short spring is configured to be come into contact with a portion of the male terminal to be inserted into the female terminal. When the male terminal and the female terminal are electrically connected with each other, the female housing is configured to be inserted between the male terminal and the short spring.

### CROSS-REFERENCE TO RELATED APPLICATIONS

This application is based on and claims priority under 35 USC 119 from Japanese Patent Application No. 2023-081736 filed on May 17, 2023, the contents of which are incorporated herein by reference.

### TECHNICAL FIELD

The present disclosure relates to a connector structure and a male connector.

### BACKGROUND ART

As a connector structure in the related art, a half-fitting prevention connector described in JP2012-064461A has been proposed. According to the half-fitting prevention connector in JP2012-064461A, a male connector is provided with a short spring that short-circuits a plurality of male terminals to prevent the erroneous operation before fitting with a female connector. The female connector is provided with a short circuit release plate portion that is inserted between the male terminal and the short spring when the male connector is fitted.

In the male connector in the related art described above, the short spring is in contact with a box portion provided behind a male tab to be inserted into a female terminal. Therefore, in the female connector, it is necessary to cause the thin plate-shaped short circuit release plate portion to protrude to the front side with respect to the fitting surface of a female housing.

Since this thin plate-shaped short circuit release plate portion has low strength, the short circuit release plate portion may be damaged during fitting or due to the external force. When the short circuit release plate portion is damaged, small debris enters the terminal contact point, causing poor contact. The short circuit between the male terminals caused by the short spring cannot be released.

The present disclosure provides a connector structure and a male connector with improved strength.

### SUMMARY OF INVENTION

In accordance with the present disclosure, a connector structure includes a male connector including a plurality of male terminals, a short spring configured to come into contact with the plurality of male terminals, and a male housing configured to house the plurality of male terminals and the short spring, and a female connector including a plurality of female terminals configured to be electrically connected to the plurality of male terminals and a female housing configured to house the plurality of female terminals. The short spring is configured to be come into contact with a portion of the male terminal to be inserted into the female terminal. When the male terminal and the female terminal are electrically connected with each other, the female housing is configured to be inserted between the male terminal and the short spring.

According to the present disclosure, a male connector includes a plurality of male terminals configured to be electrically connected to a female terminal, a short spring configured to come into contact with the plurality of male terminals, and a male housing configured to house the plurality of male terminals and the short spring. The short spring is configured to be come into contact with a portion of the male terminal to be inserted into the female terminal.

The present disclosure has been briefly described above. Further, the details of the present disclosure can be clarified by reading modes (hereinafter, referred to as “embodiments”) for carrying out the disclosure to be described below with reference to the accompanying drawings.

### BRIEF DESCRIPTION OF DRAWINGS

FIG. 1 is a longitudinal cross-sectional view showing a connector structure according to an embodiment of the present disclosure before fitting;

FIG. 2 is a perspective view of a female connector in FIG. 1;

FIG. 3 is a cross-sectional view taken along a line A-A in FIG. 1;

FIG. 4 is a longitudinal cross-sectional view of the connector structure shown in FIG. 1 during fitting; and

FIG. 5 is a longitudinal cross-sectional view of the connector structure shown in FIG. 1 after fitting.

### DESCRIPTION OF EMBODIMENTS

A specific embodiment of the present disclosure will be described below with reference to the drawings.

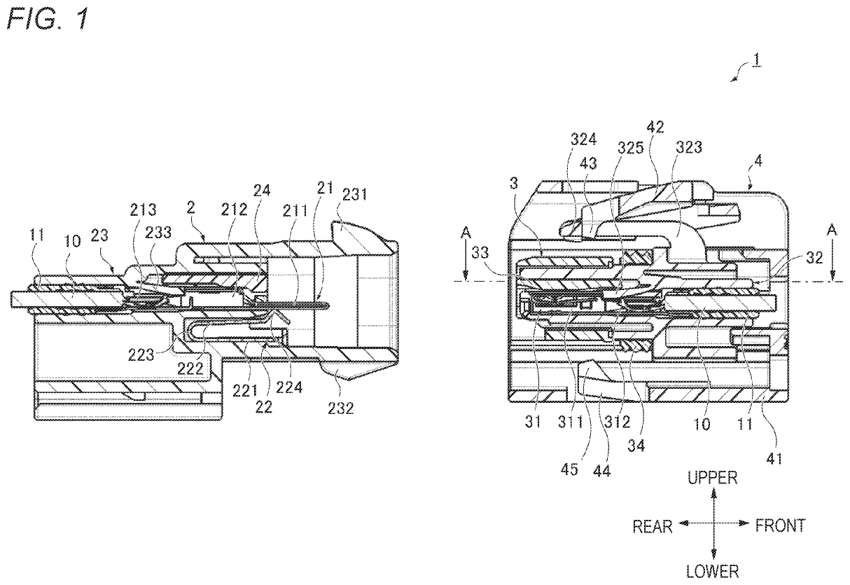

Hereinafter, for convenience of description, as shown in FIGS. 1 to 5, “front”, “rear”, “left”, “right”, “upper”, and “lower” are defined. The “front-rear direction”, the “left-right direction”, and the “upper-lower direction” are orthogonal to one another.

As shown in FIG. 1, a connector structure 1 according to the present embodiment includes a male connector 2, a female connector 3 to be fitted to the male connector 2, and a fitting position guarantee lock (CPA) 4 slidably attached to the outside of the female connector 3.

The male connector 2 includes two male terminals 21, a short spring 22 that comes into contact with the two male terminals 21, a male housing 23 that houses the male terminals 21 and the short spring 22, and a male front retainer 24.

The male terminal 21 is provided by punching out and bending a conductive metal plate. The male terminal 21 is housed in the male housing 23 such that the longitudinal direction is along the front-rear direction. The two male terminals 21 are housed in the male housing 23 side by side in the left-right direction. The male terminal 21 includes a male tab 211, a substantially rectangular cylindrical box portion 212, and an electric wire connection portion 213.

The male tab 211 is provided on the front side (the female connector 3 side) and is formed in a tab shape. The male tab 211 is inserted into the female terminal 31 and is electrically connected to the female terminal 31. The box portion 212 is provided adjacent to the rear side (the side away from the female connector 3) of the male tab 211, and is formed in a box shape including a bottom portion substantially flush with the male tab 211. The electric wire connection portion 213 is provided adjacent to the rear side of the box portion 212 and is attached to the end of the electric wire 10. A rubber plug 11 is externally fitted to the end of the electric wire 10, and the portion to which the rubber plug 11 is externally fitted is housed in the male housing 23.

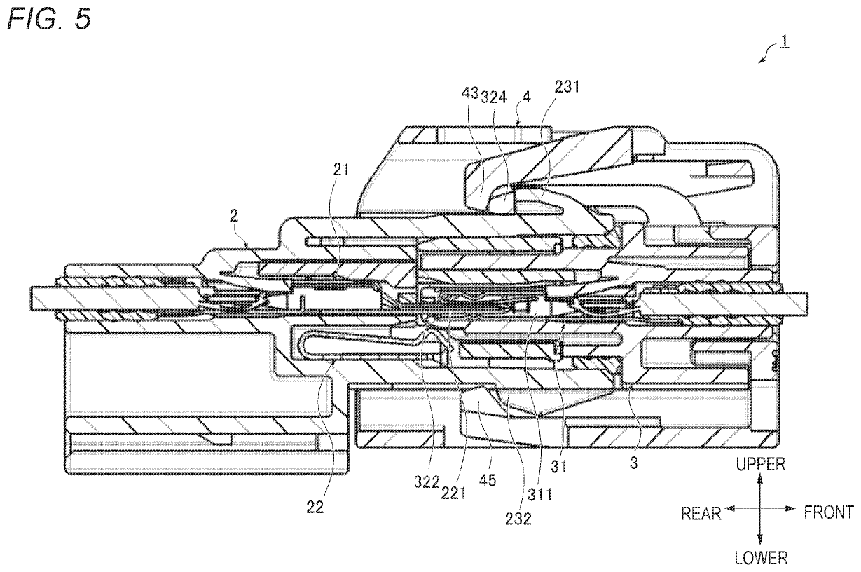

The short spring 22 is provided by punching out and bending a conductive metal plate. As shown in FIG. 1, in a state in which the male connector 2 and the female connector 3 are not fitted to each other, the short spring 22 comes into contact with the male tab 211 to be inserted into the female terminal 31 and short-circuits the two male terminals 21. In other words, when the male connector 2 and the female connector 3 are fitted to each other, the short spring 22 comes into contact with the male terminal 21 on the front side with respect to the fitting surface where the rear end of the female terminal 31 is located. On the other hand, as shown in FIG. 5, in a state in which the male connector 2 and the female connector 3 are fitted to each other, the connection between the short spring 22 and the male terminal 21 is released by inserting a short circuit release portion 322 of the female connector 3 between the short spring 22 and the male tab 211.

As shown in FIG. 1, in the present embodiment, the short spring 22 is housed below the male terminal 21. The short spring 22 includes a lower plate 221 provided on the inner side surface of the lower side of the male housing 23, an upper plate 222 provided on the upper side of the lower plate 221, and a connecting plate 223 connecting the rear ends of the lower plate 221 and the upper plate 222, and is formed approximately in a U shape. According to the above configuration, the front end of the upper plate 222 is flexible in the upper-lower direction. A contact point 224 that protrudes upward and that comes into contact with the male tab 211 is provided at the front end of the upper plate 222. The front end portion of the contact point 224 is provided with an inclined surface that approaches the male tab 211 as being away from the front end.

The male housing 23 is made of an insulating member such as resin. The male housing 23 includes an upper lock beak 231, a lower lock beak 232, and a male housing lance 233. The upper lock beak 231 and the lower lock beak 232 protrude upward and downward from the outer side surface of the cylindrical male housing 23. The upper lock beak 231 is engaged with the upper lock beak 324 of the female connector 3 to be described later. The lower lock beak 232 is engaged with a lower lock beak 45 of the CPA 4 to be described later. The male housing lance 233 protrudes forward and downward from the inner side surface of the cylindrical male housing 23, and is engaged with the box portion 212 of the male terminal 21.

The male front retainer 24 is made of an insulating member such as resin. The male front retainer 24 is inserted from the front opening of the male housing 23 and is housed in the male housing 23. The male front retainer 24 is inserted between the distal end of the male housing lance 233 and the inner side surface of the male housing 23. Accordingly, the distal end of the male housing lance 233 is bent toward the inner side surface of the male housing 23 to prevent the male housing lance 233 from being disengaged from the male terminal 21.

The female connector 3 includes two female terminals 31 electrically connected to the two male terminals 21, the female housing 32 that houses the two female terminals 31, and a female front retainer 33 and a packing 34 that are externally fitted to the female housing 32.

The female terminal 31 is provided by punching out and bending a conductive metal plate. The female terminal 31 is housed in the female housing 32 such that the longitudinal direction is along the front-rear direction. The two female terminals 31 are housed in the female housing 32 side by side in the left-right direction. The female terminal 31 includes a substantially rectangular cylindrical box portion 311 and an electric wire connection portion 312.

The box portion 311 is provided on the rear side (the male connector 2 side). A contact spring electrically connected to the male tab 211 is provided in the box portion 311. The electric wire connection portion 312 is provided adjacent to the front side (the side away from the male connector 2) of the box portion 311, and the end of the electric wire 10 is attached thereto. The rubber plug 11 is externally fitted to the end of the electric wire 10, and the portion to which the rubber plug 11 is externally fitted is housed into the female housing 32.

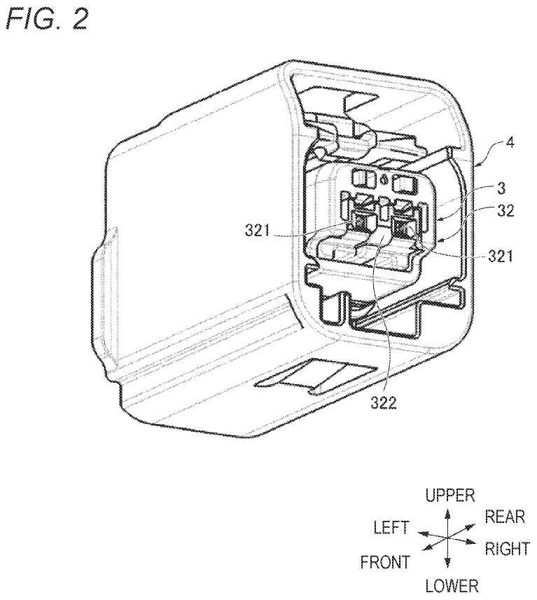

The female housing 32 is made of an insulating member such as resin. As shown in FIG. 2, the female housing 32 includes two terminal accommodating chambers 321 and the short circuit release portion 322. The two terminal accommodating chambers 321 are arranged side by side in the left-right direction, and the female terminals 31 are accommodated one by one.

The short circuit release portion 322 is provided in the female housing 32 in a manner of protruding from the outer surface of the distal end portion between the terminal accommodating chamber 321 and the terminal accommodating chamber 321. When the male connector 2 and the female connector 3 are fitted to each other, the short circuit release portion 322 pushes down the contact point 224 of the short spring 22 and is inserted between the male tab 211 and the short spring 22. The short circuit release portion 322 is provided with an inclined surface that extends downward as being away from the rear end (the distal end), that is, is away from the female terminal 31.

As shown in FIG. 1, the female housing 32 includes a pair of lock arms 323 and 323, an upper lock beak 324, and a female housing lance 325. The pair of lock arms 323 and 323 protrude upward from the upper outer side surface of the female housing 32, extend toward the rear side (the male connector 2 side), and include rear ends that are flexible in the upper-lower direction. The pair of lock arms 323 and 323 are arranged side by side in the left-right direction. The upper lock beak 324 connects the rear ends of the pair of lock arms 323 and 323.

The female housing lance 325 protrudes rearward and downward from the inner side surface of the terminal accommodating chamber 321, and is engaged with the female terminal 31.

The female front retainer 33 is made of an insulating member such as resin. The female front retainer 33 is inserted from the rear side of the female housing 32 and is partially accommodated in the terminal accommodating chamber 321. The female front retainer 33 accommodated in the terminal accommodating chamber 321 is inserted between the distal end of the female housing lance 325 and the inner side surface of the terminal accommodating chamber 321. Accordingly, the distal end of the female housing lance 325 is bent toward the inner side surface of the terminal accommodating chamber 321 to prevent the female housing lance 325 from being disengaged from the female terminal 31.

The packing 34 is externally fitted into the female housing 32 on the front side with respect to the female front retainer 33.

The CPA 4 is attached to the female connector 3 in a manner of being slidable in the front-rear direction. The CPA includes a substantially rectangular cylindrical housing 41 that houses the female connector 3, an upper lock arm 42, an upper lock beak 43, a lower lock arm 44, and a lower lock beak 45. The upper lock arm 42 extends rearward and downward from the upper side in the housing 41, and includes a rear end that is flexible in the upper-lower direction. The upper lock beak 43 protruding downward is provided at the rear end of the upper lock arm 42. The lower lock arm 44 extends rearward and upward from the lower side in the housing 41, and includes a rear end that is flexible in the upper-lower direction. A lower lock beak 45 protruding upward is provided at the rear end of the lower lock arm 44.

The CPA 4 is slidable between the final locking position (see FIG. 5) at which the upper lock beak 43 is located on the rear side with respect to the upper lock beak 324 of the female connector 3 and the temporary locking position (see FIG. 1) at which the upper lock beak 43 is located on the front side with respect to the upper lock beak 324 of the female connector 3.

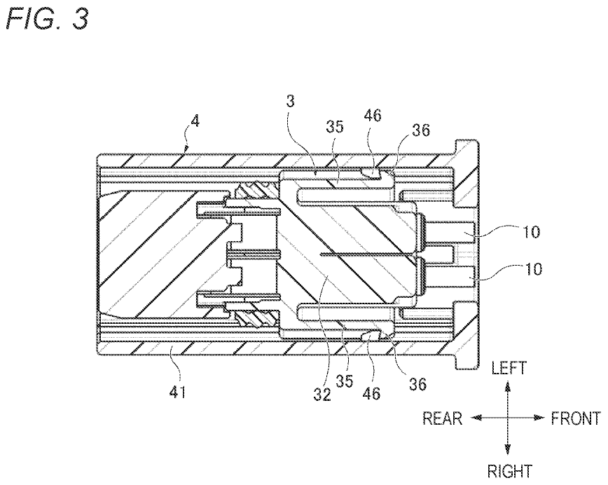

As shown in FIG. 3, the female connector 3 includes a pair of lock arms 35 and 35 and a pair of female housing side locks 36 and 36. The CPA 4 includes a pair of CPA side locks 46 and 46. The pair of lock arms 35 and 35 extend forward from the left and right outer side surfaces of the female housing 32, and include front ends that are flexible in the left-right direction. The pair of female housing side locks 36 and 36 protruding outward in the left-right direction are provided at the front ends of the pair of lock arms 35 and 35. The CPA side lock 46 protrudes from the left and right inner side surfaces of the housing 41. When the CPA 4 is at the temporary locking position, the female housing side lock 36 and the CPA side lock 46 are engaged with each other.

Next, a procedure for fitting the male connector 2 and the female connector 3 described above will be described. The female connector 3 accommodates the female terminal 31 in the terminal accommodating chamber 321 when the CPA 4 is slid to the rear side and is at the final locking position. After the female terminal 31 is accommodated, as shown in FIG. 1, the male connector 2 and the female connector 3 are fitted to each other in a state in which the CPA 4 is slid to the front side and is at the temporary locking position. Before the male connector 2 and the female connector 3 are fitted to each other, the short spring 22 is in contact with the male terminal 21.

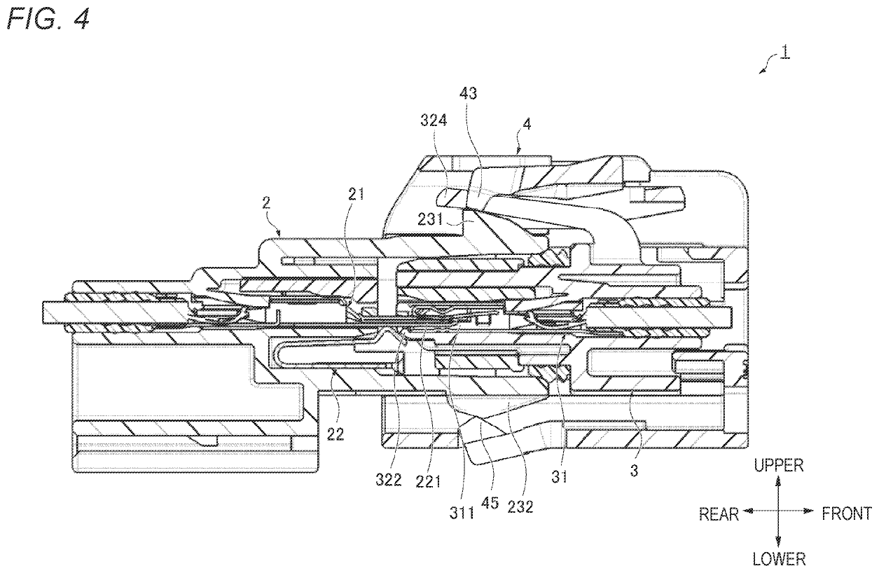

When the male connector 2 and the female connector 3 are further brought close to each other, as shown in FIG. 4, the male tab 211 of the male terminal 21 is inserted into the box portion 311 of the female terminal 31, and the contact point 224 of the short spring 22 abuts against the short circuit release portion 322 provided in the female housing 32. At this time, the upper lock beak 324 of the female connector 3 and the upper lock beak 43 of the CPA 4 ride on the upper lock beak 231 of the male connector 2, and the lower lock beak 45 of the CPA 4 rides on the lower lock beak 232 of the male connector 2.

When the male connector 2 and the female connector 3 are further brought close to each other, as shown in FIG. 5, the short spring 22 is pushed down by the short circuit release portion 322 along the inclined surface of the contact point of the short spring 22 and the inclined surface of the short circuit release portion 322, and the short circuit release portion 322 is inserted between the male tab 211 and the short spring 22. Accordingly, the short circuit between the two male terminals 21 is released. The upper lock beak 324 of the female connector 3 rides over the upper lock beak 231 of the male connector 2 and is located at the rear side of the upper lock beak 231. Accordingly, the male connector 2 and the female connector 3 are completely fitted to each other. When the male connector 2 and the female connector 3 are completely fitted to each other, the CPA 4 slides to the rear side, and the upper lock beak 43 of the CPA 4 rides over the upper lock beak 324 of the female connector 3 and is located on the rear side of the upper lock beak 324. The lower lock beak 45 of the CPA 4 rides over the lower lock beak 232 of the female connector 3 and is located on the rear side of the lower lock beak 232.

According to the above embodiment, the short spring 22 is brought into contact with a portion of the male terminal 21 to be inserted into the female terminal 31. Therefore, it is not necessary to cause the plate-shaped short circuit release portion 322 to protrude from the female housing 32 as in the related art, and the female housing 32 itself can be used as the short circuit release portion 322. Therefore, the strength can be improved.

According to the above embodiment, the strength can be further improved by protruding between the terminal accommodating chamber 321 and the terminal accommodating chamber 321 of the female housing 32 and forming the short circuit release portion 322.

According to the above embodiment, the short circuit release portion 322 is provided with an inclined surface that is away from the female terminal 31 as being away from the distal end. Therefore, the short spring 22 is pushed along the inclined surface, and the short circuit release portion 322 can be smoothly inserted between the short spring 22 and the male tab 211.

The present disclosure is not limited to the above embodiment, and can be appropriately modified, improved, or the like. In addition, materials, shapes, sizes, numbers, arrangement positions and the like of components in the above embodiment are freely selected and are not limited as long as the present disclosure can be implemented.

For example, in the above embodiment, the CPA 4 slidably attached to the female connector 3 is provided. However, providing the CPA 4 is not essential and may be omitted.

Here, the features of the embodiment of the connector structure and the male connector according to the present disclosure described above are briefly summarized and listed in the following (i) to (iv).
(i)

A connector structure (1) including:
a male connector (2) including a plurality of male terminals (21), a short spring (22) configured to come into contact with the plurality of male terminals (21), and a male housing (23) configured to house the plurality of male terminals (21) and the short spring (22); and
a female connector (3) including a plurality of female terminals (31) configured to be electrically connected to the plurality of male terminals (21) and a female housing (32) configured to house the plurality of female terminals (31),
in which the short spring (22) is configured to be come into contact with a portion of the male terminal (21) to be inserted into the female terminal (31), and
in which, when the male terminal (21) and the female terminal (31) are electrically connected with each other, the female housing (32) is configured to be inserted between the male terminal (21) and the short spring (22).

According to the configuration in the above (i), the short spring (22) is brought into contact with a portion of the male terminal (21) to be inserted into the female terminal (31). Therefore, it is not necessary to cause the plate-shaped short circuit release portion (322) to protrude from the female housing (32) as in the related art, and the female housing (32) itself can be used as the short circuit release portion (322). Therefore, the strength can be improved.
(ii)

The connector structure (1) according to (i),
in which the female housing (32) includes a plurality of terminal accommodating chambers (321) configured to each accommodate one of the plurality of female terminals (31), and a short circuit release portion (322) provided with a protruding outer surface of a distal end portion located between adjacent terminal accommodating chambers (321), and
in which the short circuit release portion (322) is configured to be inserted between the male terminal (21) and the short spring (22).

According to the configuration in the above (ii), the strength can be further improved by protruding between the terminal accommodating chamber (321) and the terminal accommodating chamber (321) of the female housing (32) and forming the short circuit release portion (322).
(iii)

The connector structure (1) according to (ii),
in which the short circuit release portion is provided with an inclined surface, the inclined surface being away from the female terminal (31) as being away from a distal end.

According to the configuration in the above (iii), the short circuit release portion (322) is provided with an inclined surface that is away from the female terminal (31) as being away from the distal end. Therefore, the short spring (22) is pushed along the inclined surface, and the short circuit release portion (322) can be smoothly inserted between the short spring (22) and the male tab (211).
(iv)

A male connector (2) including:
a plurality of male terminals (21) configured to be electrically connected to a female terminal (31);
a short spring (22) configured to come into contact with the plurality of male terminals (21); and
a male housing (23) configured to house the plurality of male terminals (21) and the short spring (22),
in which the short spring (22) is brought into contact with a portion of the male terminal (21) to be inserted into the female terminal (31).

According to the configuration in the above (iv), the short spring (22) is brought into contact with a portion of the male terminal (21) to be inserted into the female terminal (31). Therefore, it is not necessary to cause the plate-shaped short circuit release portion (322) to protrude from the female housing (32) as in the related art, and the female housing (32) itself can be used as the short circuit release portion (322). Therefore, the strength can be improved.

What is claimed is:

1. A connector structure comprising:
a male connector including a plurality of male terminals, a short spring configured to come into contact with the plurality of male terminals, and a male housing configured to house the plurality of male terminals and the short spring; and
a female connector including a plurality of female terminals configured to be electrically connected to the plurality of male terminals and a female housing configured to house the plurality of female terminals,
wherein the short spring is configured to be come into contact with a portion of the male terminal to be inserted into the female terminal, and
wherein, when the male terminal and the female terminal are electrically connected with each other, the female housing is configured to be inserted between the male terminal and the short spring.

2. The connector structure according to claim 1,
wherein the female housing includes a plurality of terminal accommodating chambers configured to each accommodate one of the plurality of female terminals, and a short circuit release portion provided with a protruding outer surface of a distal end portion located between adjacent terminal accommodating chambers, and
wherein the short circuit release portion is configured to be inserted between the male terminal and the short spring.

3. The connector structure according to claim 2,
wherein the short circuit release portion is provided with an inclined surface, the inclined surface being away from the female terminal as being away from a distal end.

4. A male connector comprising:
a plurality of male terminals configured to be electrically connected to a female terminal;
a short spring configured to come into contact with the plurality of male terminals; and
a male housing configured to house the plurality of male terminals and the short spring,
wherein the short spring is configured to be come into contact with a portion of the male terminal to be inserted into the female terminal.
